(19) United States
(12) Patent Application Publication
(10) Pub. No.: US 2009/0244283 A1
(43) Pub. Date: Oct. 1, 2009

(54) SYSTEM AND METHOD FOR DISPLAYING IMAGES OF THE SURROUNDINGS OF A MOTOR VEHICLE

(76) Inventor: Mario Beier, Diekholzen (DE)

Correspondence Address: KENYON & KENYON LLP, ONE BROADWAY, NEW YORK, NY, 10004, US

(21) Appl. No.: 12/303,451

(22) PCT Filed: May 24, 2007
(86) PCT No.: PCT/EP2007/055030

§ 371 Date: May 21, 2009

(30) Foreign Application Priority Data
Jun. 29, 2006 (DE) 10 2006 029 994.9

(51) Int. Cl. H04N 7/18

(52) U.S. Cl. 348/148; 348/E07.085

(57) ABSTRACT

An assemblage for displaying a portion of the surroundings of a motor vehicle includes a camera with which a portion of the vehicle surroundings is imageable, and a display device with which an imaged portion of the vehicle surroundings can be displayed as a surroundings image, at least one further display device being provided, by which the surroundings image can be displayed. A motor vehicle may be equipped with such an assemblage, and to a method may be provided for displaying a portion of the surroundings of a vehicle.

### FIELD OF THE INVENTION

The present invention relates to a system or an assemblage for displaying a portion of the surroundings of a motor vehicle, the assemblage encompassing a camera with which a portion of the vehicle surroundings can be imaged, as well as a display device with which an imaged portion of the vehicle surroundings can be displayed as a surroundings image.

### BACKGROUND INFORMATION

To assist the drivers of motor vehicles, it is known to use video-based driver assistance systems that present, in a display, images acquired by a camera disposed on the vehicle. The driver can in this fashion be assisted, for example with a reversing camera system, in discerning parking-space boundaries or obstacles when reversing into a parking space. In the context of so-called night vision systems the driver can be effectively assisted by the use of infrared-sensitive image sensors or cameras, even in poor viewing or weather conditions and at night.

DE 40 32 927 discloses an assemblage of this kind for improving viewing conditions in a motor vehicle. Provided for this purpose is an infrared-sensitive camera that senses the viewing area of the vehicle surroundings observed in front of the driver of the motor vehicle. The signal delivered by the camera is conveyed to a display apparatus that displays for the driver, as a surroundings image, the portion of the surroundings imaged by the camera. It is proposed here in particular to embody the display apparatus as a head-up display, and to project the portion of the surroundings imaged by the camera, as a virtual image, onto the windshield within the driver's field of view.

It is furthermore usual to provide, as the only display device of such an assemblage, a display that either can form a constituent of a combination instrument or else can be inserted as a central display into the instrument panel of a motor vehicle.

### SUMMARY

Example embodiments of the present invention provide an assemblage of the kind cited above that also makes it possible for further persons readily to discern the surroundings image acquired by the camera.

According to example embodiments of the present invention, at least one further display device is provided, by which the surroundings image acquired by the camera can be displayed.

An assemblage of this kind has the advantage, as compared with the previously known systems, that not only is the driver assisted, even in poor viewing conditions, in discerning the vehicle's surroundings, but other passengers, in particular a front-seat passenger, also receive the same information regarding the imaged vehicle surroundings by a separate display device or on a separate display.

In this fashion, the passengers can also readily view the images acquired by the camera of the surroundings preferably located in front of the vehicle, and can, if applicable, give additional instructions to the driver regarding objects that are more difficult to discern; this can further enhance traffic safety.

Advantageous refinements of and improvements to the assemblage and the system according to example embodiments of the present invention are described below.

It is particularly advantageous, for example, if a switching device is provided with which a selection can be made as to which of the multiple display devices available globally is to display the surroundings image acquired by the camera. The switching device either can be arranged such that display of the acquired surroundings image is possible only on a single selectable display device, or can also provide simultaneous reproduction on multiple display devices.

According to an example embodiment of the system according to the present invention, provision is made that at least one further display device is disposed in the front region of the passenger compartment of the vehicle such that a passenger sitting next to the driver can easily discern the displayed surroundings image without complex contortions.

According to an example embodiment of the system according to the present invention, provision is made that at least one, preferably two, further display devices is/are disposed in the rear-seat region of the passenger compartment of the vehicle such that passengers sitting on the rear seat behind the driver can readily discern the displayed surroundings image. Advantageously, corresponding displays that can serve as additional display devices according to the present invention can be recessed into the seatbacks or the headrests of the front seats.

It is furthermore particularly advantageous in this context if the further display devices disposed in the rear-seat region of the passenger compartment are a constituent of a rear-seat entertainment system that is provided, if applicable, in a vehicle. The assemblage can be arranged particularly economically in this fashion.

It is furthermore particularly advantageous if the camera is arranged as an infrared-sensitive camera that is a constituent of a night vision system. It is thereby possible for, in particular, passengers sitting behind the driver or front-seat passenger also to keep track of driving events located in front of the vehicle in poor viewing conditions or at night.

The assemblage can be used not only in passenger cars but also, advantageously, in tour buses. In addition to wire-based connection of the individual display devices, another advantageous possibility is wireless connection of the additional display devices to the camera or to a control unit connected to the camera. For example, transmission of image data to the additional display devices can be accomplished via radio (Bluetooth).

The assemblage further includes at least one interface connected directly or indirectly to the camera, by which further display devices that each have a corresponding mating interface can be connected to the assemblage. An assemblage of this kind has the advantage, in particular, that the number of additional display devices on which the surroundings image acquired by the camera can be displayed is not predetermined by the assemblage itself, but rather is variable so as to allow adaptation to different applications. For example, it is also possible in particular for the passengers in a tour bus to connect their appropriately equipped (Bluetooth-capable) mobile telephones to the interface of the assemblage so that depending on individual interest, they can also keep track of the traffic events imaged by the preferably forward-directed camera as a surroundings image.

Example embodiments of the present invention provide a motor vehicle that includes an assemblage of the kind described above. A motor vehicle of this kind can advantageously be a passenger car or a tour bus.

Example embodiments of the present invention further provide a method for displaying a portion of the surroundings of a vehicle, which method can advantageously be carried out on an assemblage or a system of the kind described above. For this, a portion of the vehicle's surroundings is imaged with a camera, and is displayed as a surroundings image by a first display device and at least one further display device.

The drawings depict exemplifying embodiments of the present invention that are explained in further detail in the description below.

### BRIEF DESCRIPTION OF THE DRAWINGS

FIG. 1 schematically depicts a system according to an example embodiment of the present invention; and

FIG. 2 schematically depicts a system according to an example embodiment of the present invention.

### DETAILED DESCRIPTION

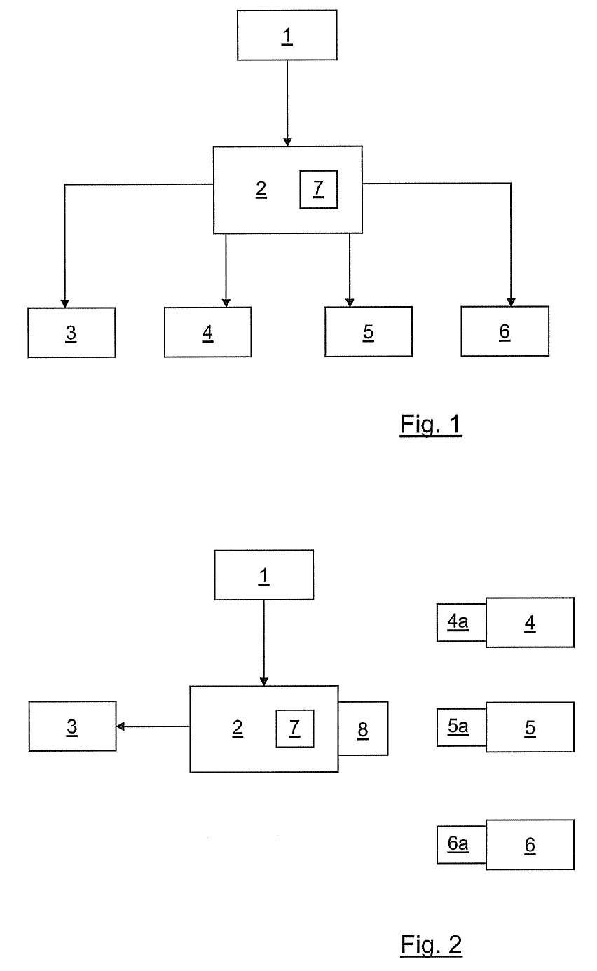

The assemblage depicted in FIG. 1 is utilized in a passenger car. It includes an infrared-sensitive camera 1 that is disposed in the front region of the vehicle and can image the region of the vehicle's surroundings located in front of the vehicle, even in poor viewing conditions and at night. Suitable infrared headlights are provided on the vehicle for this purpose in a, e.g., conventional, manner. The image data acquired by camera 1 are conveyed to a control unit 2 that is connected to a total of four display devices 3, 4, 5, 6 via electrical leads. First display 3 is constituted by a display that is disposed in the vehicle's combination instrument behind the steering wheel, and is readily discernible only by the driver. Alternatively, this first display device 3 could also be arranged as a head-up display.

The first additional display device 4 is located above the glove compartment in front of the front passenger seat, while the two additional display devices 5 and 6 are located, as part of a rear-seat entertainment system, in the headrests of the two front seats, in order to display to the passengers sitting in back the surroundings image acquired by camera 1.

Control unit 2 has a selector switch 7 with which the driver, in particular, can define the display devices 3, 4, 5, 6 (totaling four in number) on which the surroundings images are to be displayed.

In the assemblage depicted in FIG. 2, only first display device 3 is connected to control unit 2 via an electrical lead. Additional display devices 4, 5, 6 communicate via radio with control unit 2 in order to receive in wireless fashion the surroundings images acquired by camera 1. For this purpose, control unit 2 has an interface 8 through which corresponding radio signals are delivered. Additional display devices 4, 5, 6 each have a corresponding separate interface 4a, 5a, 6a in order to provide reception of the image data transferred via radio. In this fashion, not only the three additional display devices 4, 5, 6 depicted in FIG. 2, but any number of additional display devices, can be connected in particularly simple fashion to control unit 2 and thus to camera 1, so that each can display the acquired surroundings images.

1-10. (canceled)

11. An assemblage for displaying a portion of surroundings of a motor vehicle, comprising:
a camera adapted to image a portion of the surroundings of the motor vehicle;
a display device adapted to display an imaged portion of the surroundings of the motor vehicle; and
at least one further one further display device adapted to display the surroundings image.

12. The assemblage according to claim 11, further comprising a switch device adapted to select at least one display device for delivery of the surroundings image.

13. The assemblage according to claim 11, wherein a further display device is arranged in a front region of a passenger compartment of the vehicle such that a displayed surroundings image is visible to a front-seat passenger.

14. The assemblage according to claim 11, wherein at least one further display device is arranged in a rear-seat region of a passenger compartment of the vehicle such that a displayed surroundings image is visible to a passenger sitting on a rear seat.

15. The assemblage according to claim 14, wherein at least one further display device arranged in the rear-seat region of the passenger compartment of the vehicle is part of a rear-seat entertainment system.

16. The assemblage according to claim 11, wherein the camera is an infrared-sensitive camera that is part of a night vision system.

17. The assemblage according to claim 11, wherein the display devices are connectable wirelessly to at least one of (a) the camera and (b) a control unit (2) connected to the camera.

18. The assemblage according to claim 11, further comprising at least one interface connected at least one of (a) directly and (b) indirectly to the camera by which further display devices are connectable to the assemblage.

19. A motor vehicle, comprising:
an assemblage adapted to display a portion of surroundings of the motor vehicle, the assemblage including:
a camera adapted to image a portion of the surroundings of the motor vehicle;
a display device adapted to display an imaged portion of the surroundings of the motor vehicle; and
at least one further one further display device adapted to display the surroundings image as recited in at least one of the preceding claims.

20. A method for displaying a portion of surroundings of a vehicle, comprising:
imaging a portion of the surroundings with a camera;
displaying the surroundings as a surroundings image by a display device; and
displaying the surroundings image by at least one further display device.
